(19) United States
(12) Patent Application Publication
(10) Pub. No.: US 2010/0187048 A1
(43) Pub. Date: Jul. 29, 2010

(54) Caliper brake

(76) Inventor: Edward L. Chandler, St. Joseph, MI (US)

Correspondence Address: Edward G. Greive;Renner, Kenner, Greive, Bobak, Taylor & Weber, Fourth Floor, First National Tower, Akron, OH, 44308-1456, US

(21) Appl. No.: 12/321,586

(22) Filed: Jan. 23, 2009

(51) Int. Cl. B62L 3/02; F16C 1/14

(52) U.S. Cl. 188/26; 74/502.6

(57) ABSTRACT

A caliper brake including a housing, an opening in the housing, and an actuating assembly received in the opening. The actuating assembly includes an actuating lever having a cam surface and a pivot aperture, a cable bracket having a cable retaining flange, a pivot aperture, and a retaining portion, and a pin received through said pivot apertures to rotatably secure the actuating lever to the cable bracket. The retaining portion of the cable bracket acts to secure the actuating assembly in the opening of the housing without the need for mechanical fasteners. A pivot plate may also be provided, the pivot plate having a pivot aperture and a retaining portion, and is positioned on one side of the actuation lever opposite the cable bracket. A cable housing is received in a bore through the cable retaining flange, and an actuation cable is slidably positioned therein and secured at one end to the actuation lever. When the cable is moved, the actuation lever pivots relative to the cable bracket to actuate the brake.

### TECHNICAL FIELD

This invention relates to a caliper brake having opposing stators actuated by a cable to engage a rotor to provide a braking force. More particularly, this invention relates to such a caliper brake including a cable housing through which the cable slides, wherein the cable housing is mounted directly to a cable bracket secured to the brake's housing.

### BACKGROUND ART

Caliper brakes are well known and widely used within the industrial equipment industry, as well as other industries, to provide a braking force on a vehicle with rotating wheels. Caliper brakes may be provided in a variety of forms, including, for example, mechanically, hydraulically, or pneumatically actuated caliper brakes, and spring actuated and hydraulically released caliper brakes, just to name a few. Mechanically actuated caliper brakes often utilize a cable connected at one end to a brake control mechanism, and at another end to an actuating lever. When the brake control mechanism is actuated, the cable is moved thereby causing movement of the actuating lever. The actuating lever is equipped with a cam surface that causes a pair of opposed stator assemblies to move toward one another and engage a rotor therebetween.

A common problem with conventional mechanically actuated caliper brakes relates to the positioning of the cable relative to the actuating lever. A cable housing is provided around the cable and is conventionally secured to the vehicle to retain the cable therein. In prior art designs, the cable travels from the brake control mechanism, through the cable housing, and is then secured to the actuating lever. Because the cable housing is mounted to the vehicle, the cable induces a moment on the caliper brake assembly when pulled. This moment causes the stators to wear unevenly, thereby requiring more frequent replacement.

Another frequent problem encountered in conventional caliper brakes is a slow response time between the actuation of the brake control mechanism and the inducement of braking forces by the caliper brake assembly. This delay is caused in large part by a high number of components connecting the cable to the caliper brake assembly. The slack, or loose cable, must be taken up at each component before the cable acts to move the actuating lever, so a higher number of components results in an increased response time. An additional consideration affecting all caliper brakes are weight and cost issues. As might be expected, it is desirable to provide caliper brake assemblies that are as lightweight and as inexpensive as possible while meeting the performance characteristics required for the intended use of the brake.

Thus, the need exists for a caliper brake that is not subjected to a caliper induced moment causing uneven wear of the brake pads, that has an improved response time, and that is lightweight and inexpensive.

### DISCLOSURE OF THE INVENTION

It is thus an object of one aspect of the present invention to provide a caliper brake having a cable bracket that receives a cable housing therein.

It is an object of another aspect of the present invention to provide a caliper brake, as above, wherein the actuating lever pivots about a pin on the cable bracket to reduce the number of components and improve the response time of the brake.

It is an object of another aspect of the present invention to provide a caliper brake, as above, wherein the cable bracket is mounted to the brake housing without the use of fasteners, thereby reducing the weight and cost of the brake.

These and other objects of the present invention, as well as the advantages thereof over existing prior art forms, which will become apparent from the description to follow, are accomplished by the improvements hereinafter described and claimed.

In general, a caliper brake actuating mechanism according to at least one aspect of the present invention includes an actuating lever and a cable bracket. A bore is provided through the cable bracket and a cable housing is received in the bore. An actuating cable is slidably received in the cable housing and is secured at one end to the actuating lever. Movement of the actuating cable causes pivoting of the actuating lever, which thereby causes actuation of the caliper brake.

In accordance with at least one aspect of the present invention a caliper brake includes a housing, an opening in the housing, and an actuating assembly received in the opening of the housing. The actuating assembly includes an actuating lever having a cam surface, a cable bracket, and a pin rotatably securing the actuating lever to the cable bracket. The actuating assembly is secured within the opening of the housing by the retaining portion of the cable bracket without the need for mechanical fasteners.

In accordance with at least one aspect of the present invention, a caliper brake assembly includes a housing, an opening in the housing, and an actuating assembly received in the opening of the housing. The actuating assembly includes an actuating lever having a cam surface and a cable bracket having a retaining portion. A bore is provided through the cable bracket and a cable housing is received in the bore of the cable bracket. An actuating cable is slidably received in the cable housing and is secured at one end to the actuating lever. A clevis pin rotatably secures the actuating lever to the cable bracket to allow pivoting of the actuating lever relative to the cable bracket. The actuating assembly is secured within the opening of the housing by the retaining portion of the cable bracket without requiring the use of mechanical fasteners.

A preferred exemplary caliper brake according to the concepts of the present invention is shown by way of example in the accompanying drawings without attempting to show all the various forms and modifications in which the invention might be embodied, the invention being measured by the appended claims and not by the details of the specification.

### BRIEF DESCRIPTION OF THE DRAWINGS

FIG. 1 is a top plan view of a caliper brake according of the present invention.

FIG. 2 is a side elevational view of the caliper brake of FIG. 1.

FIG. 3 is an exploded view of the caliper brake of FIG. 1.

FIG. 4 is a sectional view taken substantially across line 3-3 of FIG. 2.

FIG. 5 is a top plan view of the pivot plate of the caliper brake of FIG. 1.

FIG. 6 is a top plan view of the cable bracket of the caliper brake of FIG. 1.

FIG. 7 is a side elevational view of the cable bracket of FIG. 5.

FIG. 8 is a bottom plan view of the cable bracket of FIG. 5.

### PREFERRED EMBODIMENTS FOR CARRYING OUT THE INVENTION

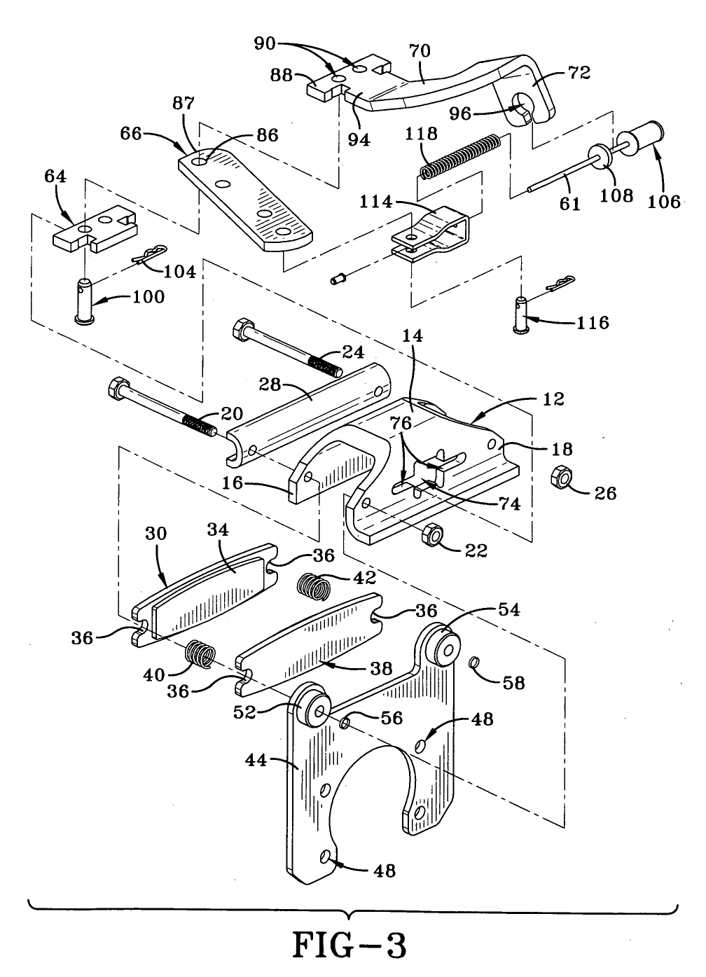

A caliper brake made in accordance with the present invention is indicated generally by the numeral 10. Caliper brake 10 includes a housing, generally indicated by the numeral 12, having a top wall 14, and opposed sidewalls 16 and 18 (FIG. 3). Housing 12 has a generally U-shaped cross-section, with sidewall 16 and sidewall 18 being displaced from one another and connected by top wall 14. A bolt 20 is received in a pair of coaxial holes in sidewall 16 and sidewall 18, and is secured therein by a nut 22 positioned adjacent to sidewall 18. Another bolt 24 is received in a separate pair of coaxial holes in sidewall 16 and sidewall 18 displaced from the bolt 20, and is secured therein by a nut 26 positioned adjacent to sidewall 18. A secondary plate 28 may be provided adjacent to sidewall 16 secured by bolt 20 and bolt 24 passing through apertures therein. Secondary plate 28 adds rigidity to sidewall 16.

A first stator assembly 30 is provided within housing 12 and is slidably received on bolt 20 and bolt 24. First stator assembly 30 includes a stator plate 32 and a brake pad 34 secured thereto, as is well known in the art. The stator plate 32 is used to mount the stator assembly 30, and the brake pad 34 has a high friction surface and is used to provide a braking force. Stator plate 32 may have recesses 36, which may also be in the form of holes, on each end that fit over bolts 20 and 24, thereby slidably mounting first stator assembly 30 within housing 12 (FIG. 3). First stator assembly 30 is provided adjacent to sidewall 16, and is positioned so as to have brake pad 34 facing sidewall 18. A second stator assembly 38, identical to first stator assembly 30 and having a stator plate 32, brake pad 34, and recesses 36 for receiving bolts 20 and 24, is positioned closer to sidewall 18 than first stator assembly 30, with brake pad 34 facing first sidewall 16. First stator assembly 30 and second stator assembly 38 are axially displaced on bolts 20 and 24 to allow a rotating member of the vehicle to fit therebetween, as will be described in greater detail hereinafter.

A compression spring 40 is positioned on bolt 20 between first stator assembly 30 and second stator assembly 38, and a compression spring 42 is positioned on bolt 24 between first stator assembly 30 and second stator assembly 38. Compression springs 40 and 42 act to bias the caliper brake 10 in an unactuated position. Specifically, due to the position of first stator assembly 30 adjacent to and in contact with sidewall 16, compression springs 40 and 42 act to force second stator assembly 38 away from first stator assembly 30.

A bracket weldment 44, having brake mounting holes therein, is received on bolts 20 and 24, and extends generally parallel to sidewall 18. Bracket weldment 44 is positioned adjacent to second stator assembly 38. Bolts 20 and 24 are received through the brake mounting holes to secure bracket weldment 44 to caliper brake 10. Bracket weldment 44 may be provided with a plurality of vehicle mounting holes 48 to allow it to be secured to a vehicle. Thus, caliper brake 10 is secured in position over a rotating member of the vehicle by bracket weldment 44, which is secured to a stationary component of the vehicle. A spacer 52 and a spacer 54 may be provided on bolt 20 and bolt 24, respectively, between sidewall 18 of housing 12 and bracket weldment 44. Bushings 56 and 58 are positioned within spacers 52 and 54 and receive bolts 20 and 24 therethrough, thereby allowing the entire caliper assembly to move axially along bolts 20 and 24 to center itself on the rotating member of the vehicle.

An actuating assembly generally indicated by the numeral 60 is engaged with an actuating cable 61 and is selectively actuated to cause axial movement of second stator assembly 38, thereby generating a braking force. Actuating assembly 60 includes a pivot plate 64, an actuating lever 66, and a cable bracket 68 having a cable retaining flange 72. Actuating assembly 60 is received in an opening 74 (FIGS. 3 and 4) in sidewall 18 of housing 12. Opening 74 is substantially aligned with bracket weldment opening 50 to facilitate actuation of the caliper brake 10, as will be discussed in greater detail hereinafter. Opening 74 in housing 12 has a generally square profile with slots 76 (FIG. 3) extending from each side of the opening at the approximate vertical center.

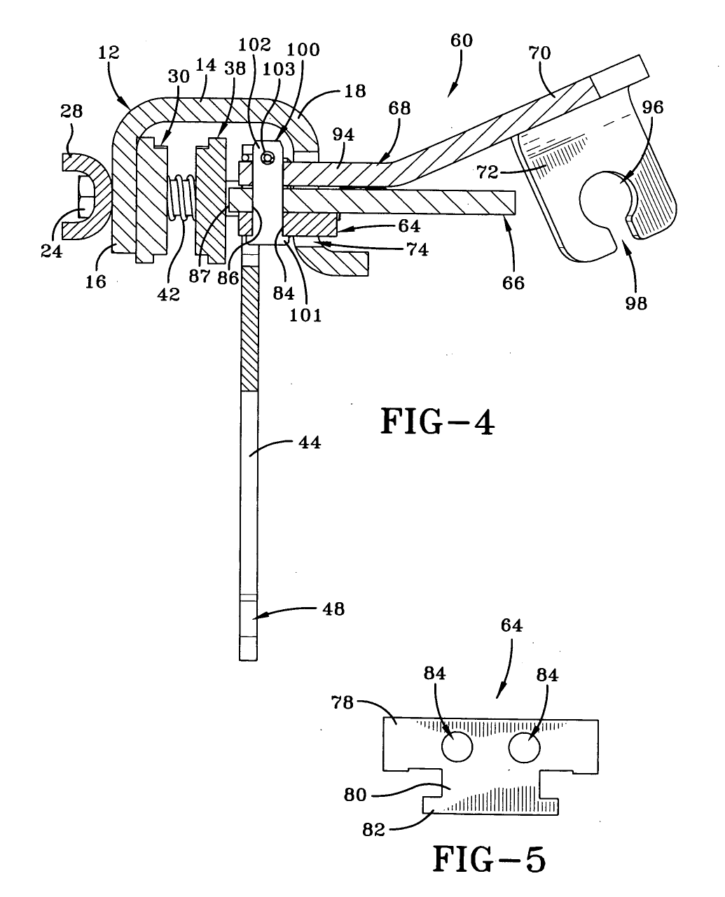

As shown in FIG. 5 pivot plate 64 includes a retaining portion 78, a neck 80, and an outer retaining portion 82. The retaining portion 78 has a width greater than the width of opening 74, but less than the width of opening 74 and slots 76. Thus, during the assembly of caliper brake 10, retaining portion 78 may be inserted through opening 74 and slots 76, and then may be lowered into position with retaining portion 78 engaged with the interior of second sidewall 18 to prevent removal of pivot plate 64 in a direction opposite first sidewall 16. Outer retaining portion 82 also has a width greater than the width of opening 74 to prevent pivot plate 64 from sliding through opening 74 in the direction of sidewall 16. Pivot plate 64 also includes two pivot apertures 84 extending through retaining portion 78. Actuating lever 66 is positioned above and is in contact with pivot plate 64, and includes at least one pivot aperture 86 and a cam surface 87 adjacent to and in contact with second stator assembly 38. The pivot aperture 86 in actuating lever 66 is aligned with one of the pivot apertures 84 in pivot plate 64. Actuating lever 66 is positioned on a plane P that is generally perpendicular to sidewall 18.

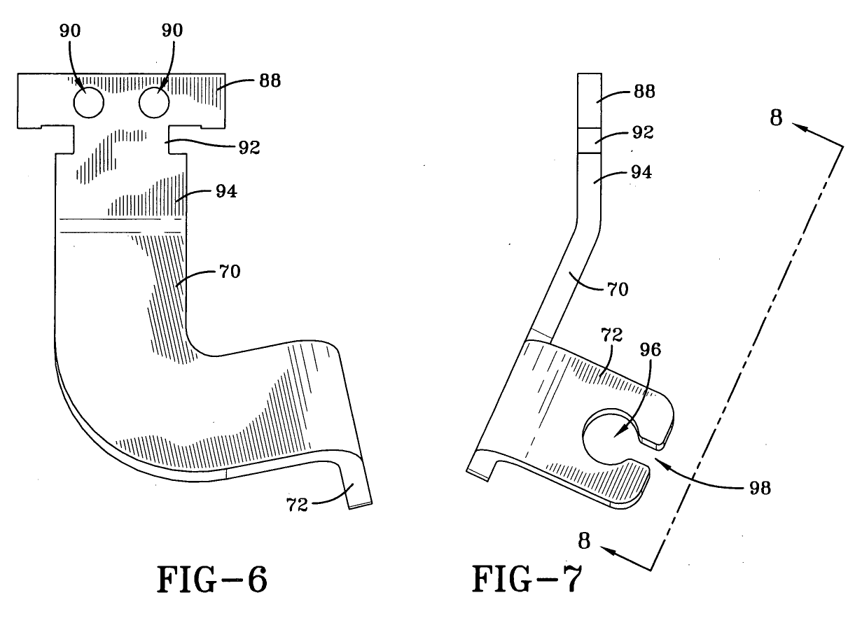

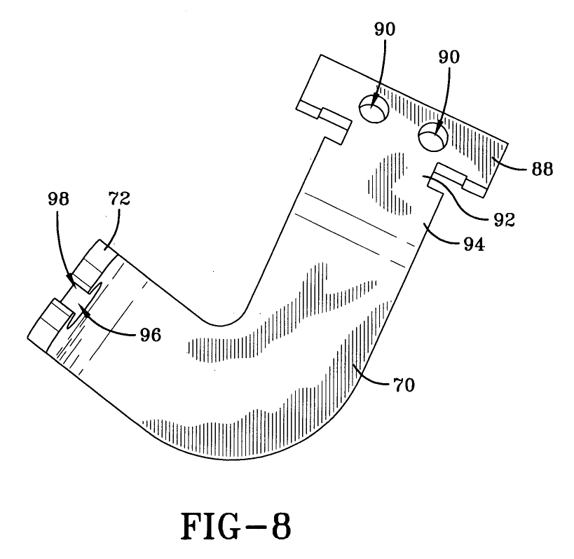

Cable bracket 68 includes a retaining portion 88 having pivot apertures 90, and a neck 92 substantially identical to pivot plate 64 (FIGS. 6-8). Thus, cable bracket 68 is secured within opening 74 by retaining portion 88 engaging the interior of sidewall 18 in the same manner as described above. Cable bracket 68 has a body 94 that serves a function that is similar to outer retaining portion 82 of pivot plate 64 in that it prevents cable bracket 68 from being removed in a direction toward first sidewall 16, but is extended in length relative to outer retaining portion 82. Body 94 of cable bracket 68 is integral with an arm 70 which includes a cable retaining flange 72. The arm 70 is a continuation of body 94 that is generally L-shaped and extends away from housing 12 at a vertical angle relative to actuation lever 66. Cable retaining flange 72 is a projection extending generally perpendicularly from arm 70 at an end opposite body 94, and is integral with arm 70 and body 94. Cable retaining flange 72 includes a bore 96 therethrough, and a slot 98 creating an opening into bore 96. As a result of the angle of arm 70 relative to body 94, as well as the downward projection of cable retaining flange 72, the center of bore 96 is substantially aligned with the plane P of actuating lever 66 (FIG. 4).

Pivot plate 64, actuating lever 66, and cable bracket 68 are connected by a clevis pin 100 extending through one of the pivot apertures 84 of pivot plate 64, pivot aperture 86 of actuating lever 66, and one of the pivot apertures 90 of cable bracket 68. As is well known to those skilled in the art, clevis pin 100 allows rotation of the connected parts about the axis of the pin. Clevis pin 100 includes a head 101, a shank 102, and a hole 103 passing through shank 102 at the opposite end of the pin from head 101. A cotter pin 104 is inserted through hole 103 to keep clevis pin 100 in place after assembly of the parts. Thus, pivot plate 64, actuating lever 66, and cable bracket 68 are prevented from moving relative to one another except for rotational movement about clevis pin 100. When assembled and secured within opening 74 of housing 12, however, pivot plate 64 and cable bracket 68 are prevented from pivoting relative to housing 12 by retaining portions 78 and 88, thereby allowing only actuating lever 66 to pivot about clevis pin 100 relative to pivot plates 64 and 68.

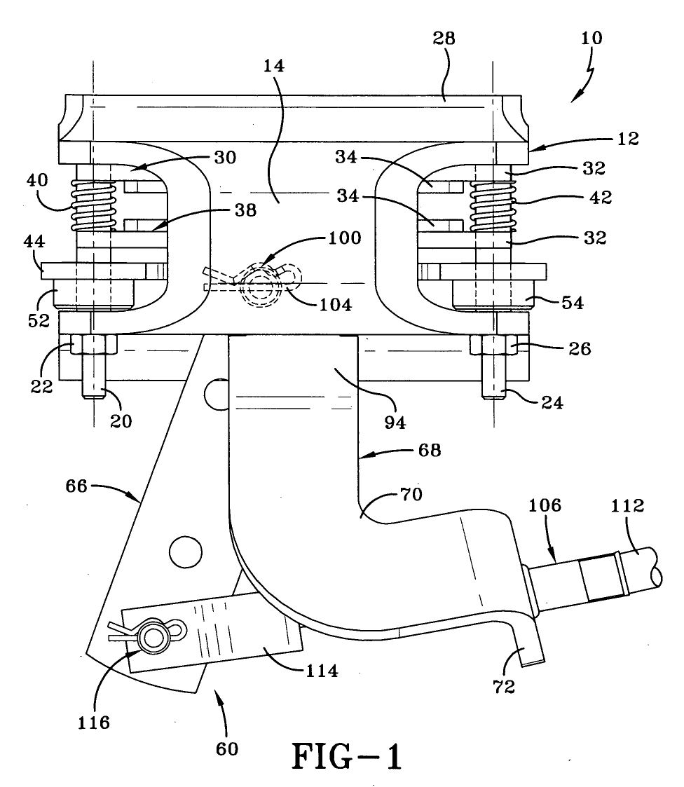

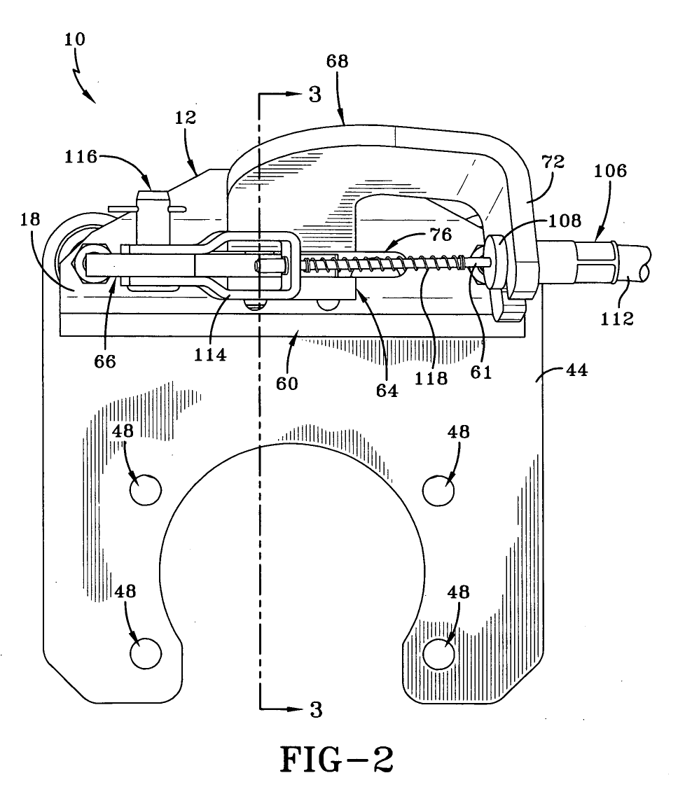

A cable housing 106 is received in bore 96 and is secured therein by one or more integral retaining flanges 108 (FIGS. 1-3). Cable housing 106 is generally cylindrical and has a bore therethrough. Actuating cable 61 is received within said bore and extends in a direction away from caliper brake 10 and is connected at one end to an actuating mechanism (not shown). The actuating mechanism may be any conventional mechanism known in the art for causing axial movement of actuating cable 61, such as, for example, a lever connected at one end to the actuating cable 61. Actuating cable 61 may be enclosed in a protective tube 112 between the actuating mechanism and cable housing 106. It will be appreciated by those skilled in the art that cable housing 106 provides a fixed location for actuating cable 61 adjacent to caliper brake 10 to reduce the amount of wasted movement of the cable when actuated, thereby increasing both response time and mechanical advantage of the brake. The actuation cable 61 extends from cable housing 106 and is secured at its other end to a mounting bracket 114 pivotally secured to actuating lever 66 by a clevis pin 116. A compression spring 118 may be provided over actuating cable 61 between cable housing 106 and mounting bracket 114 to bias the actuating assembly to an unactuated position.

When the actuating mechanism is engaged, actuating cable 61 is caused to slide axially through cable housing 106 away from caliper brake 10. This movement causes actuating lever 66 to pivot about clevis pin 100 toward cable retaining flange 72. Pivoting of actuating lever 66 causes cam surface 87 to engage second stator assembly 38, and forces it to slide axially toward first stator assembly 30 as actuating lever 66 rotates, thereby causing brake pads 34 to engage the rotating member of the vehicle positioned between the stator assemblies 30 and 38. The high friction surfaces of the brake pads 34 create a braking force to stop rotation of the rotating member, which is rotationally secured to a vehicle axle.

By mounting cable housing 106 to cable retaining flange 72 of cable bracket 68, rather than to the vehicle itself, the moment induced upon the caliper brake 10 that is present in prior art brake designs is eliminated. In addition, by securing actuating lever 66 directly to cable bracket 68 by clevis pin 100, the cable travel necessary to actuate the brake is reduced as a result of the reduced number of components relative to prior art caliper brake designs. Furthermore, the caliper brake is simplified in that it does not require additional fasteners to secure cable bracket 68 within housing 12.

It is thus evident that a caliper brake constructed as described herein accomplishes the objects of the present invention and otherwise substantially improves the art.

What is claimed is:

1. An apparatus for actuating a caliper brake comprising an actuating lever, a cable bracket, a bore through said cable bracket, a cable housing received in said bore of said cable bracket, and an actuating cable slidably received in said cable housing and secured at one end to said actuating lever, wherein movement of said actuating cable causes pivoting of said actuating lever thereby actuating the caliper brake.

2. The apparatus for actuating a caliper brake of claim 1, further comprising a pivot aperture through said actuating lever, a pivot aperture through said cable bracket, and a pin received in said pivot apertures to rotatably secure said actuating lever and said cable bracket together.

3. The apparatus for actuating a caliper brake of claim 2, further comprising a pivot plate having a pivot aperture, wherein said actuating lever is positioned between said pivot plate and said cable bracket and said pin passes through said pivot aperture in said pivot plate.

4. The apparatus for actuating a caliper brake of claim 1, wherein said cable bracket includes a body positioned on a first plane and an arm extending from said body positioned on a second plane that is angled relative to said first plane, said arm having a first portion extending in a common direction with said body and a second portion oriented generally perpendicular to said first portion and extending away from said actuating lever when said actuating lever is in an unactuated position.

5. The apparatus for actuating a caliper brake of claim 4, wherein said cable bracket includes a cable retaining flange extending from said second portion toward said first plane of said body, said bore being positioned through said retaining flange.

6. The apparatus for actuating a caliper brake of claim 5, wherein said bore through said retaining flange includes a central axis, said actuating lever is positioned on a third plane generally parallel with said first plane of said body, and said central axis of said bore lies approximately on said third plane of said actuating lever.

7. The apparatus for actuating a caliper brake of claim 3, the brake having a housing with an opening, wherein said pivot plate, said actuating lever, and said cable bracket are secured within the opening in the housing.

8. The apparatus for actuating a caliper brake of claim 7, wherein said pivot plate and said cable bracket each include a retaining portion, said retaining portions securing said pivot plate, said actuating lever, and said cable bracket within the opening without the use of mechanical fasteners.

9. The apparatus for actuating a caliper brake of claim 8, wherein the opening in the housing includes a pair of aligned slots extending outwardly from opposing sides, said slots being adapted to receive said retaining portions.

10. The apparatus for actuating a caliper brake of claim 1, wherein said actuating lever includes a cam surface.

11. The apparatus for actuating a caliper brake of claim 1, further comprising a compression spring on said actuating cable between said cable bracket and said actuating lever, wherein said compression spring biases said actuating lever in an unactuated position.

12. A caliper brake assembly comprising a housing, an opening in said housing, and an actuating assembly received in said opening in said housing, said actuating assembly including an actuating lever having a cam surface, a cable bracket, and a pin rotatably securing said actuating lever to said cable bracket, said actuating assembly being secured within said opening in said housing by said retaining portion of said cable bracket without the need for mechanical fasteners.

13. The caliper brake of claim 12, further comprising a pivot aperture through said actuating lever, a pivot aperture through said cable bracket, and a pin received in said pivot apertures to rotatably secure said actuating lever and said cable bracket together.

14. The caliper brake of claim 13, further comprising a pivot plate having a retaining portion and a pivot aperture, said actuating lever being positioned between said pivot plate and said cable bracket and said pin passing through said pivot aperture in said pivot plate, wherein said retaining portion of said pivot plate acts to secure said actuating assembly within said opening in said housing.

15. The caliper brake of claim 12, further comprising a first stator assembly and a second stator assembly, said second stator assembly being positioned adjacent said cam surface of said actuating lever, wherein pivoting of said actuating lever causes said cam surface to engage said second stator assembly, thereby moving said second stator assembly toward said first stator assembly.

16. The caliper brake of claim 15, further comprising a bore through said cable bracket, a cable housing received in said bore of said cable bracket, and an actuating cable slidably received in said cable housing and secured at one end to said actuating lever, wherein movement of said actuating cable causes pivoting of said actuating lever thereby moving said second stator assembly toward said first stator assembly.

17. A caliper brake assembly comprising a housing, an opening in said housing, and an actuating assembly received in said opening in said housing, said actuating assembly including an actuating lever having a cam surface, a cable bracket having a retaining portion, a bore through said cable bracket, a cable housing received in said bore of said cable bracket, an actuating cable slidably received in said cable housing and secured at one end to said actuating lever, and a pin rotatably securing said actuating lever to said cable bracket, said actuating assembly being secured within said opening in said housing by said retaining portion of said cable bracket without the need for mechanical fasteners.

18. The caliper brake of claim 17, further comprising a pivot plate having a retaining portion and a pivot aperture, said actuating lever being positioned between said pivot plate and said cable bracket and said pin passing through said pivot aperture in said pivot plate, wherein said retaining portion of said pivot plate acts to secure said actuating assembly within said opening in said housing.
